(19) United States
(12) Patent Application Publication
(10) Pub. No.: US 2026/0213936 A1
(43) Pub. Date: Jul. 23, 2026

(54) SYSTEMS AND METHODS FOR AUTONOMOUS AND DYNAMIC SECURITY CONFIGURATION GENERATION

(71) Applicant: Wells Fargo Bank, N.A., San Francisco, CA (US)

(72) Inventors: Rameshchandra Bhaskar Ketharaju, Hyderabad (IN); Suresh Reddy, Hyderabad (IN); Karthikeyan Nallakamachi, Bangalore (IN); Justin Blackburn, Litchfield Park, AZ (US); Sajeev Philip, New Delhi (IN); Ravi Babu Bandla, Bangalore (IN)

(21) Appl. No.: 19/033,250

(22) Filed: Jan. 21, 2025

(51) Int. Cl. H04L 9/08

(52) U.S. Cl. CPC H04L 9/088

(57) ABSTRACT

Systems, apparatuses, methods, and computer program products are disclosed for cryptographic operation determination. An example method includes creating a set of analysis data based upon input data and analyzing the analysis data to determine security category classification. The example method further includes determining a security configuration based on the security category classification. The example method also includes instantiating agent programs for the enactment of cryptographic operations. Finally, the example method further includes causing the execution of cryptographic operations.

### BACKGROUND

Cryptographic operations enable files, documents and other data to be securely handled. Encryption enables access to the unencrypted data, contained within an encrypted file, only when the correct encryption key is provided. Thus, users who do not have the encryption key do not have ready access to the data securely stored within. The length of the encryption key is one factor that determines the security level of the encrypted data, and as such can be varied based on the desired security of the data and the desired computational load required to encrypt the data. The encryption key should be rotated frequently to ensure the security of the data against brute force attacks against the encryption key.

### BRIEF SUMMARY

The security of documents, files and/or other data is essential in industries that handle sensitive information, for example, healthcare, banking, and finance. To maintain the security of documents, files and/or other data, a computationally intensive encryption process is enacted. The documents, files and/or other data are encrypted, and an encryption key of a particular length is produced to allow access to the data contained within. However, the encryption process is a tradeoff between security and computational load and/or time. Thus, there are a variety of levels of encryption that can be used on data with respect to the required security level.

The development of quantum computers and the increasing adoption of post-quantum cryptography (PCQ) mean that the security of encrypted data is under constant threat. To improve the security of encrypted data against quantum cryptography, longer key lengths are required and/or more computationally expensive cryptographic algorithms/systems may be adopted. The longer the key lengths required and/or the more computationally expensive the cryptographic operations are, the more expensive they are to run. As such, encryption often requires a determination of which data is requiring of the higher security, and subsequently higher costs to produce and maintain the cryptographic security of the data.

Traditionally, it has been up to the end user to determine the encryption type, key length and/or other properties associated with cryptographic operations. While for technical users, this may not be an issue, it can be viewed as a limitation for regular users of services that require document encryption or other cryptographic operations. Regular users may not be aware of the organizational requirements for cryptographic operations, the sensitivity of data that they are working with, and/or the efficacy of different cryptographic operations for data security. In addition, it has traditionally been up to the end user to determine the schedule for key rotation, and/or for the user to remember to change the key manually, to ensure the continued protection of the data.

In contrast to these conventional techniques for key generation, example embodiments described herein automatically recommend and/or perform various cryptographic operations. The automatic cryptographic operation determination application may operate in the background and may automatically provide recommendations and/or perform various cryptographic operations based on properties determined from ingested data. The user-facing aspect of the application may function as an add-on for email or other office applications, a desktop application, mobile application or the like. The application may include a classifier model (e.g. a language model or other AI model) for classifying data. The classifier may be trained on internal data of an organization to model a best practice for cryptographic key length decisions and other cryptographic properties. Training may thus be guided by using datasets based on different approaches to cryptographic operations. For example, a more performance-weighted approach may favor shorter keys, while a safer more secure approach may favor longer keys.

Accordingly, the present disclosure sets forth systems, methods, and apparatuses that provide automatic recommendations and/or automatically perform various cryptographic operations based on the properties determined from ingested data. There are many advantages of these, and other embodiments described herein. For instance, the key length and property determination system may automatically ingest data, for example, when a new file is created on a system. In addition, a user may manually select a file, email, or other data entity for processing to determine corresponding suggested security level and suggested cryptographic operations and/or key properties, for the data contained within. After ingesting the data, the system may provide to the user a recommendation, based on the security category classification, to perform various cryptographic operations. The recommended cryptographic operations may be encrypting and/or signing, for example, and may be provided when saving a file or before sending an email. Finally, the system may provide a recommended key length and other recommended properties for key generation and rotation, determined using the security category classification of the data and the training datasets.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 is a block diagram illustrating an implementation of the autonomous and dynamic security configuration generation system, in accordance with various aspects of the present disclosure.

FIG. 2 illustrates a schematic block diagram of example circuitry embodying a system device that may perform various operations in accordance with some example embodiments described herein.

FIG. 3 illustrates an example flowchart for autonomous and dynamic security configuration generation, in accordance with some example embodiments described herein.

FIG. 4 illustrates an example flowchart for the operation of a key rotation agent, in accordance with some example embodiments described herein.

FIG. 5 illustrates an example flowchart for the implementation of user feedback, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “input data” may refer to various data sources including a file stored on a filesystem, an email message, a binary data stream received via an application programming interface (API), and/or the like. The input data may also be considered the cryptographic payload during a cryptographic operation such as encryption, providing the raw data to be encrypted.

The term “analysis data” may refer to a step in analysis of input data, such as, rules-based cleaning of the input data. For example, input data may be analyzed by extracting the file payload, file metadata, organizational classifications, and/or the like. into a structured text file (e.g., YAML/JSON/XML file).

The term “security category” may refer to a language-based classification of file payload (e.g., “this is a bank statement” or “this is an application for a business loan”).

The term “security configuration” may refer to the key length and/or other determinations for how to encrypt, sign, or perform other cryptographic operations on the input data (e.g. key rotation timing, PQC algorithm choice, etc.)

The term “cryptographic output” may refer to the output of cryptographic operations using the security configuration, such as an encrypted or signed file.

The term “key length” may refer to the number of bits in a cryptographic key used by a cryptographic algorithm. The length of the key is proportional to the computational requirements for generation of the key, and longer keys generally ensure stronger security of the encryption or other cryptographic operations.

The term “quantum computer” refers to any computing device capable of exploiting quantum phenomena for computational analysis. A quantum computer may be a dedicated computing device or part of a computational system and/or server. Quantum computers may offer an advantage over classical (non-quantum) computers for certain operations, such as breaking traditional encryption of data.

The term “language model” refers to a specialized artificial intelligence model that has been trained on text data to understand existing content and produce output. Language models may be implemented on a variety of computing devices, including but not limited to, computers, mobile devices, and servers. Language models are probabilistic models of natural language. Language models may be implemented for a variety of tasks, including, machine translation, natural language processing and/or the like. As described in more detail below, language models may be used for natural language processing, for example the classification of language inputs. Language models may learn statistical relationships from vast text training datasets via self-supervised or semi-supervised training processes. Various language models may be used to generate outputs based on input text and a prediction of the output, informed by training datasets. Language models are neural networks that utilize the transformer architecture. Large language models (LLM) are an example of language models and are an example of generative artificial intelligence, producing a text output based on a defined text prompt.

### System Architecture

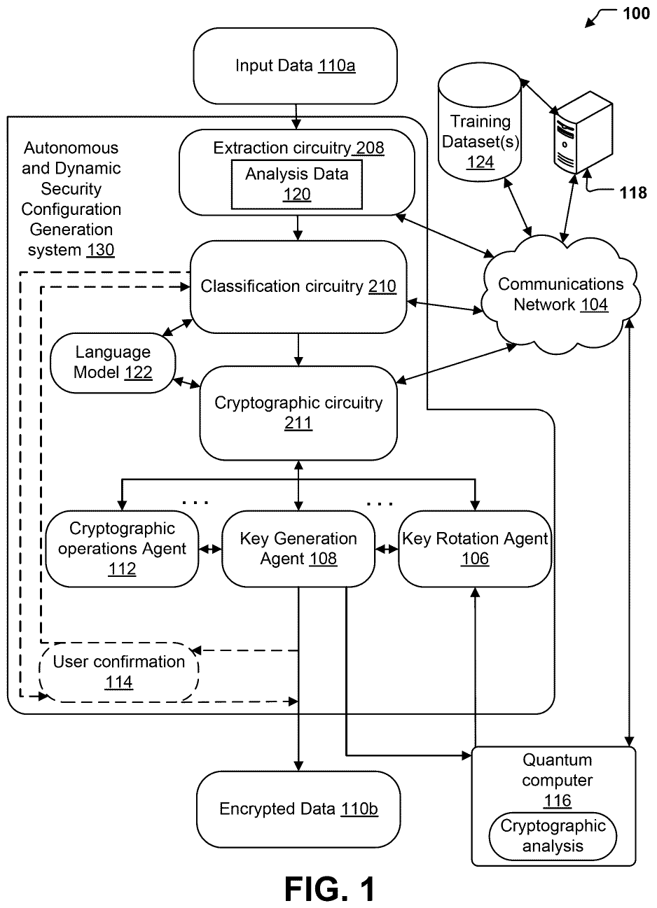

Example embodiments described herein may be implemented using any of a variety of computing devices or servers. To this end, FIG. 1 illustrates an example environment 100 within which various embodiments may operate. As illustrated, an autonomous and dynamic security configuration generation system 130 may be enacted on a variety of computing devices (e.g., computers, mobile phones, personal digital assistants, servers, etc.), may receive and/or transmit information via communications network 104 (e.g. the Internet) with any number of other devices. The autonomous and dynamic security configuration generation system 130 may be able to run in the background on a variety of local computing devices, including but not limited to computers, mobile phones, and servers. Components of the autonomous and dynamic security configuration generation system 130 may be able to run on remote computing device 118 (e.g., server) connected to the local computing device by communications network 104. Particular components of the autonomous and dynamic security configuration generation system 130 are described in greater detail below.

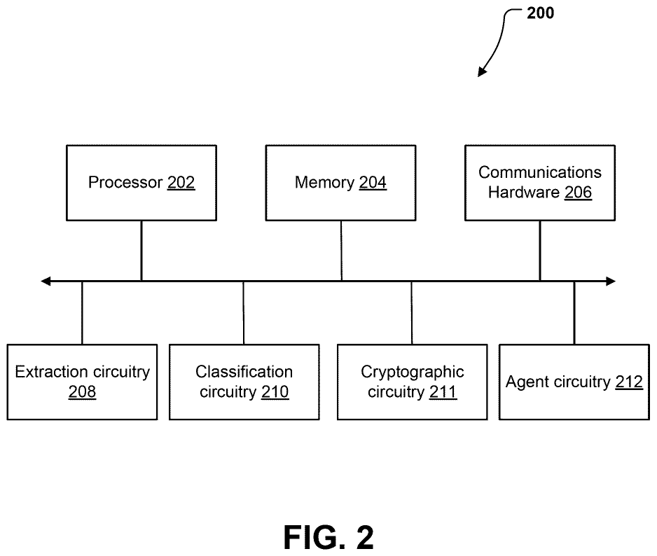

In some embodiments the autonomous and dynamic security configuration generation system 130 includes extraction circuitry 208 (described further in connection with FIG. 2 below), which may be configured to extract relevant data from an original data source, input data 110a, which may include a variety of data structures such as computer files, emails, other online messages, etc. The extraction circuitry 208 may produce analysis data 120 (e.g., set of analysis data) which may contain payload data and metadata of input data 110a. The payload data may include sample data contained within the input data 110a, for example, the subject line of an email, the title of a document, sample text from a document, etc. The metadata may include the size of the file, the type of file, where the file is stored, when the file was created, etc. In some embodiments the autonomous and dynamic security configuration generation system 130, may include classification circuitry 210 (described further in connection with FIG. 2 below), which may use the analysis data 120 to perform analysis on the input data 110a (such as determining a security category, described below) through the use of a language model (LM) 122 (for example, a large language model and/or other machine learning-based model for processing language inputs). In some embodiments the LM 122 may be implemented on a local computing device embodying the autonomous and dynamic security configuration generation system 130, in another embodiment, the LM may be implemented on a remote computing device 118 and/or any combination of local and remote implementations thereof. The remote computing device 118 may contain stored training dataset(s) 124 that may be modified by connected user feedback (e.g., user confirmation 114) from the autonomous and dynamic security configuration generation system 130.

In some embodiments, the LM 122 may be used to classify the input data 110a into security categories, based on the analysis data 120 and the training dataset(s) 124. Subsequently the cryptographic circuitry 211 (described below in connection with FIG. 2) may implement the LM 122, which may use the security category classification of the input data 110a and knowledge gained from the training dataset(s) to suggest potential cryptographic operations required for input data 110a. For example, the LM 122 may be trained on datasets specific to an organization, in which the data may be labelled with the correct security category classification, based on prior cryptographic decisions and cryptographic properties of a variety of datatypes. The training may be guided using datasets (e.g., training dataset(s) 124) based on different approaches to cryptographic operations. For example, cryptographic key generation may be performed using a more performance-weighted approach, that may favor shorter key lengths for less computationally demanding security, or a security-weighted approach, that may favor longer key lengths for greater security. In some embodiments, the model may learn the associated properties based on the unlabeled data (e.g., using unsupervised learning). The remote computing device 118 may contain stored training dataset(s) 124, for the LM 122, that may be modified by connected users using the autonomous and dynamic security configuration generation system 130. For example, by providing feedback (e.g., user confirmation 114) on the output of the classification circuitry 210 and/or the final cryptographic operation determination after agent programs (e.g., cryptographic operations agent 112, key generation agent 108, key rotation agent 106, etc.) have been initiated. Based on the training dataset(s) 124 the LM 122 may use the analysis data 120 (e.g., a set of analysis data) as an input prompt, comprising payload data (e.g., sample text, document title, etc.) and metadata (e.g., file location, file size, etc.), to classify the security category of the input data 110a, without the need for the LM 122 to parse the entirety of input data 110a, which may help alleviate the security concerns of allowing a LM 122 to access the entirety of potentially sensitive data, while still allowing the LM 122 to classify the security level of the input data 110a.

The autonomous and dynamic security configuration generation system 130, may, in various embodiments, implement agent circuitry 212 (described below in connection with FIG. 2) configured to allow the control of agent programs (key rotation agent 106, key generation agent 108, and cryptographic operations agent 112). The agent circuitry 212 may instantiate and/or control agent programs such as cryptographic operations agent 112, key generation agent 108, key rotation agent 106, and/or other agent programs. In some embodiments the cryptographic circuitry 211 may provide the determined security configuration of input data 110a and/or the recommended cryptographic operations to the various agent programs. The cryptographic operations agent 112 may, for example, generate, procure, implement, or otherwise produce the cryptographic algorithm for the signing of input data 110a (e.g., a document file and/or an email). An indication of the type of cryptographic algorithm may be provided by the cryptographic circuitry 211 communicating with LM 122 and may be based on the training dataset(s) 124 used. The cryptographic process may include the production and/or storage of signed data files, for example, a signed email ready for the user to send to the desired recipient. The key generation agent 108 may take the output from the cryptographic circuitry 211 relating to the determined security configuration and/or key length and may, for example, generate, implement, or otherwise produce the computational algorithms to ensure a generated encryption key of adequate size and thus security for the encryption of data 110a. In some embodiments, the cryptographic circuitry 211 may provide guidance concerning the key length (e.g., “key length: medium”) and the key generation agent 108 may interpret the guidance to determine an appropriate key length (in addition to determining the type of cryptographic algorithm, the implementation, and/or the like).

In some embodiments the key generation agent 108 may provide the key length and encryption data to a quantum computer 116 which may instantiate a quantum computer-based cryptographic analysis model. The quantum computer-based cryptographic analysis model may perform further security analysis on key length and encryption data. The quantum computer 116 may use cryptographic analysis, for example, quantum factoring, to break the encryption key. In this example, once the encryption key is broken the quantum computer may provide an indication of an effective strength of the key and/or the key's security to cryptographic circuitry 211 which may compare the effective strength of the cryptographic output to a pre-determined threshold. The cryptographic circuitry 211 may produce an updated security configuration based on the information received from the LM 122, historical key rotation data, contained in training dataset(s) 124, and/or the feedback from the quantum computer 116. The updated security configuration may be communicated to the key rotation agent 106. The key rotation agent 106 may, for example, determine that a new key is required to maintain the required security level of the encrypted data (e.g., if the quantum computer breaks the encryption with the current key length). A determination from the key rotation agent 106 may be communicated to the key generation agent 108, which may in turn generate a new encryption key based on updated information, provided by the key rotation agent 106 and cryptographic circuitry 211, to re-encrypt the data to ensure the data 110a remains secure.

During the encryption process the user may be asked to confirm (e.g., user confirmation 114) and/or alter the generated cryptographic operations, this provides data that may be fed back into the training datasets of LM 122 to improve the accuracy and efficacy of the produced cryptographic operations. The user confirmation 114 may be in the form of a user interface presented on the display of the local computing device running the autonomous and dynamic security configuration generation system 130. The user confirmation 114 may allow user input at various stages of the encryption process. For example, user confirmation 114 may be provided after the classification circuitry 210 classifies the security level of input data 110a and/or after the agent programs generate, implement or otherwise procure the computational algorithms for the determined cryptographic operation. In some embodiments, if the user does not agree with the classification of the input data 110a and/or with the subsequent cryptographic operation produced, the user may input a desired classification of input data 110a and/or their desired cryptographic operation. In any case, the user confirmation 114 may concern the production of encrypted data 110b with the desired key length based on the determined security level of the input data 110a, (such as an encrypted document file, an encrypted email, or the like). Encrypted data 110b may be securely stored on the computing device, transmitted via the communications network 104 to a remote computing device 118 for secure storage, emailed in a secure fashion, and/or any combination thereof. In various embodiments, the autonomous and dynamic security configuration generation system 130 works autonomously, without the need for user confirmation 114.

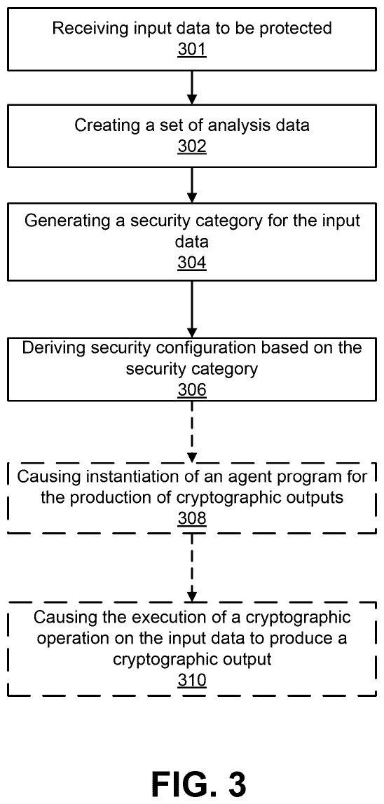

A more detailed description of the autonomous and dynamic security configuration generation system 130 components and processes are included below in connection with FIGS. 3-5, including a non/exhaustive list of example embodiments.

Particular components of the autonomous and dynamic security configuration generation system 130 are described in greater detail below with reference to apparatus 200 in connection with FIG. 2.

### Example Implementing Apparatuses

The autonomous and dynamic security configuration generation system 130 (described previously with reference to FIG. 1) may be embodied by one or more computing devices or servers, shown as apparatus 200 in FIG. 2. The apparatus 200 may be configured to execute various operations described in connection with FIG. 1 and below in connection with FIGS. 3-5. As illustrated in FIG. 2 the apparatus 200 may include processor 202, memory 204, communications hardware 206, extraction circuitry 208, classification circuitry 210, cryptographic circuitry 211 and agent circuitry 212, each of which will be described in greater detail below,

The processor 202 (and/or co-processor or any other processor assisting or otherwise associated with the processor) may be in communication with the memory 204, via a bus for passing information amongst components of the apparatus. The processor 202 may be embodied in a number of different wats and may, for example, include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware or software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g. a computer readable storage medium). The memory 204 may be configured to store information, data, content, applications, software instructions, or the like, for enabling the apparatus to carry out various functions in accordance with example embodiments contemplated herein.

The communications hardware 206 may be means such as a device or circuitry embodied in either hardware or a combination of hardware and software that is configured to receive and/or transmit data from/to a network and/or any other device, circuitry or module in communication with the apparatus 200. In this regard, the communications hardware 206 may include, for example, a network interface for enabling communications with wired or wireless communications network. For example, the communications hardware 206 may include one or more network interface cards, antennas, buses, switches, routers, modems, and supporting hardware and/or software, or any other device suitable for enabling communications via, a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an extraction circuitry 208 that processes the input data 110a (as shown in and described in connection with FIG. 1) to produce a set of analysis data (e.g., analysis data 120). The extraction circuitry 208 may utilize processor 202, memory 204, or any other hardware components included in the apparatus 200 to perform these operations, as described in connection with FIGS. 3-5 below. The extraction circuitry 208 may further utilize communications hardware 206 to gather data from a variety of sources, and/or exchange data with a user, and in some embodiments may utilize processor 202 and/or memory 204 to extract data from the input data 110a.

In addition, the apparatus 200 further comprises a classification circuitry 210 that analyzes the content of the set of analysis data (e.g., analysis data 120) to classify the security category of the input data 110a (as shown in and described in connection with FIG. 1), through the implementation of a LM 122 (FIG. 1). The classification circuitry 210 may utilize processor 202, memory 204, or any other hardware components included in the apparatus 200 to perform these operations, as described in connections with FIGS. 3-5 below. The classification circuitry 210 may further utilize communications hardware 206 to gather data from a variety of sources, for example, the extraction circuitry 208, LM 122, agent circuitry 212, quantum computer 116, a remote computing device 118 (FIG. 1), etc. The classification circuitry 210 may, in some embodiments, utilize communications hardware 206 to exchange data with a user, for example, the confirmation of the security category classification of the input data 110a. In some embodiments the classification circuitry 210 may utilize processor 202 and/or memory 204 to determine the security category classification of input data 110a.

In addition, the apparatus 200 further comprises a cryptographic circuitry 211 that is configured to derive the security configuration from the security category and the language model 122 and determine the cryptographic operations required for the input data. The cryptographic circuitry 211 may be configured to determine a security configuration including, for example, the cryptographic operations recommended based on the classified security category of the input data 110a (FIG. 1) and the training dataset(s) 124 (FIG. 1). The cryptographic circuitry 211 may utilize processor 202, memory 204, or any other hardware components included in the apparatus 200 to perform these operations, as described in connections with FIGS. 3-5 below. The cryptographic circuitry 211 may further utilize communications hardware 206 to gather data from a variety of sources, for example, LM 122, the classification circuitry 210, agent circuitry 212, quantum computer 116, a remote computing device 118 (FIG. 1), etc. The cryptographic circuitry may, in some embodiments, utilize communications hardware 206 to exchange data with a user, for example, the confirmation of the security configuration and the suggested cryptographic operations.

In addition, the apparatus 200 further comprises an agent circuitry 212 that is configured to control various agent programs which in turn may produce cryptographic output. The agent circuitry 212 may utilize processor 202, memory 204, or any other hardware component included in the apparatus 200 to perform these operations, as described in connection with FIGS. 3-5 below. The agent circuitry 212 may further utilize communications hardware 206 to gather data from a variety of sources (e.g., LM 122, classification circuitry 210, cryptographic circuitry, quantum computer 116 or a remote computing device 118, as shown in FIG. 1), and/or exchange data with a user, and in some embodiments may utilize processor 202 and/or memory 204 to control agent programs configured to produce a cryptographic output.

Although components 202-212 are described in part using functional language, it will be understood that the particular implementations necessarily include the use of particular hardware. It should also be understood certain of these components 202-212 may include similar or common hardware. For example, extraction circuitry 208, classification circuitry 210, cryptographic circuitry 211, and agent circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefor shall be interpreted as necessarily including the particular hardware configured to perform the functions associated with the particular element being described. Of course, while the term “circuitry” may in addition refer to software instructions that configure the hardware components of the apparatus 200 to perform the various functions described herein.

Although the extraction circuitry 208, classification circuitry 210, cryptographic circuitry 211, and agent circuitry 212 may leverage processor 202, memory 204, or communications hardware 206 as described above, it will be understood that any of extraction circuitry 208, classification circuitry 210, cryptographic circuitry 211 and agent circuitry 212 may include one or more dedicated processor(s), special configured field programmable gate array (FPGA), or application specific interface circuit (ASIC) to perform its corresponding functions, and may accordingly leverage processor 202 executing software stored in memory (e.g., memory 204), or communications hardware 206 for enabling any functions not performed by special-purpose hardware. In all embodiments, however it will be understood that extraction circuitry 208, classification circuitry 210, cryptographic circuitry 211, and agent circuitry 212 comprise particular machinery designed for performing the functions described herein in connection with such elements of apparatus 200.

### Example Operations

Turning to FIGS. 3, 4, and 5, example flowcharts are illustrated that contain example operations implemented by example embodiments described herein. The operations illustrated in FIGS. 3, 4 and 5 may, for example be performed by a computing device (e.g., a computer, mobile phone, server, etc.), which may be embodied by apparatus 200, which is shown and described in connection with FIG. 2. To perform the operations described below, the apparatus 200 may utilize one or more of processor 202, memory 204, communications hardware 206, extraction circuitry 208, classification circuitry 210, cryptographic circuitry 211, agent circuitry 212, and/or any combination thereof. It will be understood that user interaction with the autonomous and dynamic security configuration generation system 130 may occur directly via communications hardware 206, or may instead be facilitated by a separate remote computing device 118 (e.g., a server), and which may have similar or equivalent physical componentry facilitating such user interaction.

Turning first to FIG. 3, example processes are shown for automatic cryptographic operation determination.

As shown by process 301, the apparatus 200 includes means, such as processor 202 memory 204, communications hardware 206, or the like, for receiving input data 110a to be protected. The communications hardware 206 may receive input data 110a from a variety of sources (e.g., a remote computing device 118, a user interface, etc.).

As shown by process 302, the apparatus 200 includes means, such as processor 202, memory 204, communications hardware 206, extraction circuitry 208, or the like, for creating, based on input data, a set of analysis data (e.g., analysis data 120). The extraction of input data 110a may include the ingestion of input data into the autonomous and dynamic security configuration generation system 130 (see FIG. 1) and a production of analysis data 120 (e.g., a set of analysis data) that may be stored in a file format designed for use with artificial intelligence models. For example, input data 110a may be a document file, the extraction circuitry 208 may process the document and extract payload data (e.g., text extracts and/or document title, etc.) and/or metadata (e.g., the location of the file, the size of the file, creation date, etc.) to produce a set of analysis data (e.g., analysis data 120). In some embodiments the set of analysis data (e.g., analysis data 120) may, for example, be stored in a YAML file ready for analysis by an artificial intelligence model (e.g., a LM 122). In another example, input data 110a may be an email, the extraction circuitry 208 may process the email and extract payload data (e.g., sample of the contents, the recipient's name and position, line of business etc.) and metadata (e.g., the time the email was sent, the size of the email, etc.), and this data may be stored in a XML file and used for data analysis by an artificial intelligence model (e.g., a LM 122).

As shown by process 304, the apparatus 200 includes means, such as processor 202, memory 204, classification circuitry 210, or the like, for generating a security category for the input data 110a based on set of analysis data (e.g., analysis data 120). The classification circuitry 210, may analyze the analysis data 120 and construct an input prompt comprising sample text, from the input data 110a payload, and/or metadata of input data 110a, which may be utilized by the artificial intelligence model (e.g., LM 122) to analyze the set of analysis data (e.g., analysis data 120) and determine the security category classification (e.g., the security category) of the input data 110a. In some embodiments the LM 122 may process the analysis data 120 to extract the security category classification, the LM may, for example, be trained on datasets with category classifications based on the specific organization's best practices. The training dataset(s) 124 may be formatted to clearly delineate the features used for determining security category classification. In various embodiments, the LM 122 may produce security determination of input data 110a, based on the analysis data 120. For example, if the analysis data 120 indicates that data in the file includes personally identifiable information, the training dataset(s) 124 may label any data including this information as a high security category classification. As such the LM 122 may classify input data 110a as high security. In another example, if the analysis data 120 contains only a name and a request for a meeting, the training dataset(s) 124 may have examples of similar content labelled as a low security category classification, the LM 122 may classify input data 110a as low security.

As shown by process 306, the apparatus 200 includes means, such as processor 202, memory 204, cryptographic circuitry 211, or the like, for deriving the security configuration based on the security category. The cryptographic circuitry 211 may use the analysis data 120 and the security category classification (e.g., the product of process 304) to determine the security configuration (e.g., the cryptographic operations) required for input data 110a. The cryptographic circuitry 211 may utilize the language model (LM) 122 (see FIG. 1), that may be implemented on the computing device running the autonomous and dynamic security configuration generation system 130, or on a remote computing device via communications network 104, and or any combination thereof.

In various embodiments, the LM 122 may process the analysis data 120 to extract the security category and the security configuration. The LM may be trained on datasets with security configurations based on the specific organization's best practices. The training data may be formatted to clearly delineate the features used for determining security configuration. Training may be guided by using datasets based on different approaches to cryptographic operations, for example, a more performance-weighted approach may favor shorter encryption key lengths, whereas a more security-weighted approach may favor longer encryption key lengths. In some embodiments, the determined security category (e.g., the product of process 304) may be used to determine the required cryptographic operations (e.g., type of encryption algorithm, length of encryption key, rotation frequency of the encryption key etc.) of the input data 110a comprising the security configuration. In some embodiments, the analysis data 120 may present the LM 122 with information regarding the input data 110a. If the input data 110a is a document file containing personal identification information that is required for long term on device storage for example, the LM 122 may suggest a high security category. The LM 122 may suggest based on the high security category a security configuration that may include an asymmetric security encryption system (e.g., ECC, RSA etc.), longer key length (e.g., 1024 bit key) and a high frequency of key rotation. In another example, the set of analysis data (e.g., analysis data 120) may include information regarding an email that includes minimal user data and may only be stored for a short period before being automatically deleted, in this case the LM 122 may determine a low security category classification and a low level of cryptographic operations contained in the security configuration, for example, a symmetric encryption system (e.g., AES) and a shorter key length (e.g., 128 bits) with no requirement to rotate the key. In another example, the set of analysis data (e.g., analysis data 120) includes information regarding an email that is to be sent to client that informs them of updated services and includes no personal information, in this case the LM 122 may determine a low security category classification and no requirement for encryption, instead the security configuration may suggest the email be signed, to show that the email is from the claimed source (e.g., the bank) and has not be altered. The LM 122 may suggest the digital signature algorithms (e.g., RSA, DSA, etc.), based on the organization's policy and best practices.

As shown by process 308, the apparatus 200 includes means, such as processor 202, memory 204, agent circuitry 212, or the like for causing instantiation an agent program configured to produce a cryptographic output. In various embodiments, outputs from the cryptographic circuitry 211 (see FIG. 1) may indicate parameters for the control of the activation of agent programs that may enact the determined cryptographic operations required for the input data 110a contained in the security configuration. For example, one agent program may be a cryptographic operations agent 112 (see FIG. 1), that may encrypt the input data 110a using the encryption system determined by the cryptographic circuitry 211 and the LM 122. For example, the LM 122 may determine the input data 110a needs to be signed using an RSA encryption algorithm. The cryptographic operations agent 112 may conduct the RSA encryption process and produce signed data ready for user guided application of the encrypted data 110b (e.g., sending the email to its desired recipient). Another example agent program may be the key generation agent 108. In some embodiments, the key generation agent 108 may use the determined key length, included in the security configuration produced by the cryptographic circuitry 211 and determine the required calculations for producing this key length. Based on the implementation, this information may be communicated to other agent programs for the implementation of the cryptographic operations, or the key generation agent 108 may conduct the computations and encrypt the input data 110a and produce an encryption key of the required length, and/or any combination thereof. In some embodiments, the key generation agent 108 may communicate, via communications network 104, the encryption information to a quantum computer 116. The quantum computer 116 may conduct cryptographic analysis on the encryption, in an attempt to break the encryption. The quantum computer may communicate, via communications network 104, to another example agent program, such as the key rotation agent 106. If the quantum computer breaks the encryption key, analysis data derived from breaking the key may be communicated to the key rotation agent 106 and the cryptographic circuitry 211. The key rotation agent may be controlled by the cryptographic circuitry 211 and an updated security configuration to schedule encryption key rotation, based on the determination of the LM 122, based on the training dataset(s) 124, and the organization's best practice. If the encryption key needs to be rotated based either on the breaking of the encryption by the quantum computer 116 and/or the scheduled rotation of the key, may be communicated to the key generation agent 108, which may produce a new key based on the determination of LM 122 and the data may be re-encrypted. It will be understood that the cryptographic agent programs described here are exemplary and do not provide an exhaustive list of cryptographic agent programs that may be utilized by the autonomous and dynamic security configuration generation system 130.

As shown by process 310, the apparatus 200 includes means, such as processor 202, memory 204, agent circuitry 212, or the like, for causing the execution of a cryptographic operation on the input data based on the security configuration to produce a cryptographic output. The agent circuitry 212, in some embodiments, may allow for the control of agent programs by the cryptographic circuitry 211 to execute cryptographic operations based on the security configuration produced by the LM 122 (as described above). In some embodiments the agent program may wait for user feedback of the cryptographic operations that are to be implemented by the agent program on input data 110a. For example, user confirmation 114 (FIG. 1) that the suggested cryptographic operations included in the security configuration are in line with the organization's best practice, may be received before proceeding with the encryption and the production of encrypted data 110b. In another embodiment, the agent may proceed with the execution of cryptographic operations autonomously, without user confirmation 114. In this example, upon the agent program receiving the suggested security configuration produced by the LM 122, the cryptographic circuitry 211, the agent program may proceed to produce the desired cryptographic output (e.g., encrypted data 110b).

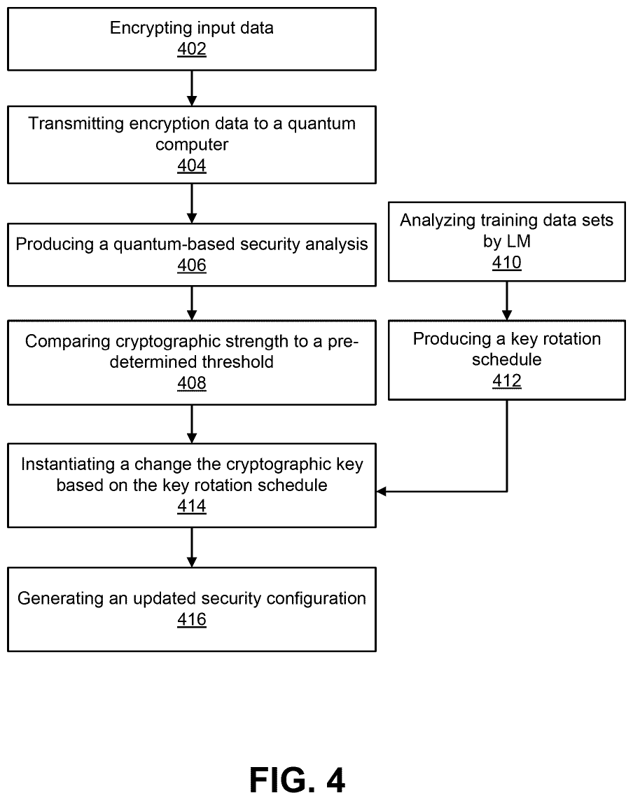

In some embodiments, the execution of cryptographic operation 308 may be performed in accordance with operations described in FIG. 4. Turning now to FIG. 4, example operations are shown for producing a quantum-based security analysis comprising an effective strength of the cryptographic output.

As shown by operation 402, the apparatus 200 may include means, such as processor 202, memory 204, agent circuitry 212, or the like, for encrypting the input data based on the security configuration. The agent circuitry may as previously described encrypt the input data 110a, through a process controlled by LM 122.

As shown by operation 404, the apparatus 200 may include means, such as communications hardware 206, or the like, for transmitting encryption data to a quantum computer. The key generation agent 108 may communicate, via communications hardware 206 and communications network 104, the encryption data (e.g., the type of encryption, the key length, the encrypted data 110b, a private key based on the cryptographic output, and the like), to the quantum computer 116.

As shown by operation 406, the apparatus 200 may include means, such as processor 202, memory 204, communications hardware 206, or the like producing a quantum-based security analysis comprising an effective strength of the cryptographic output. The quantum computer 116 may receive cryptographic data regarding the encryption of data 110a. The quantum computer may analyze the strength of the encryption, using various methods, for example, quantum factoring to determine the encryption key used, and break the encryption.

As shown by operation 408, the apparatus 200 may include means, such as processor 202, memory 204 cryptographic circuitry 211, or the like for comparing the cryptographic strength to a pre-determined threshold. The quantum computer 116 based cryptographic analysis may produce a readout of the cryptographic strength output that may be compared to a threshold value by the cryptographic circuitry 211.

As shown by operation 410, the apparatus 200 may include means, such as processor 202, memory 204, cryptographic circuitry 211, or the like for analyzing training datasets, by LM 122 instantiated by the cryptographic circuitry 211, to determine a key rotation schedule to be included in the security configuration. The LM 122 may utilize the training datasets and determined organizational best practices, alongside the security category classification of the input data 110a to determine a schedule for when the encryption key may be replaced to ensure the determined level of security is maintained for the encrypted data 110b.

As shown by operation 412, the apparatus 200 may include means, such as processor 202, memory 204, cryptographic circuitry 211, agent circuitry 212, or the like for producing a key rotation schedule, wherein the security configuration includes a cryptographic key, wherein the security configuration further comprises a key rotation schedule. The LM 122 may produce the schedule for key rotation and the cryptographic circuitry 211 may communicate this information to the key rotation agent 106 for implementation.

As shown by operation 414, the apparatus 200 may include means, such as processor 202, memory 204, cryptographic circuitry 211 agent circuitry 212, or the like for instantiating a key rotation agent 106 configured to change the cryptographic key based on the key rotation schedule, and/or on the output of the quantum cryptographic analysis conducted by the quantum computer 116. For example, the quantum computer may produce a readout of cryptographic strength that, when compared to the predetermined threshold by the cryptographic circuitry 211 (produced, for example, in operation 408) and the key rotation schedule produced by the LM 122 in relation to the security configuration (produced, for example, in operation 412) does not suggest changing the key. In such a case, the key rotation agent 106 may determine that a new key is not required at the time the determination is made. In another example, the cryptographic circuitry 211 may determine that the key needs to be changed if the cryptographic strength when compared to the threshold is determined to be inadequate. The cryptographic circuitry 211 may produce a new security configuration and communicate the new security configuration to the key rotation agent 106. The key rotation agent may subsequently interact with the key generation agent 108 which may produce a new encryption key and re-encrypt the input data 110a.

As shown by operation 416, the apparatus 200 may include means, such as processor 202, memory 204, cryptographic circuitry 211 or the like for generating an updated security configuration. The updating of the security configuration may be based on the security configuration and the quantum-based security analysis. For example, the key rotation agent 106, may determine if a new encryption key is necessary based on the security analysis conducted by the quantum computer 116. In another example, the key rotation agent may determine based on the key rotation schedule provided by the LM 122, through operation 412, that it is time to generate a new key and re-encrypt input data 110a, to maintain its security.

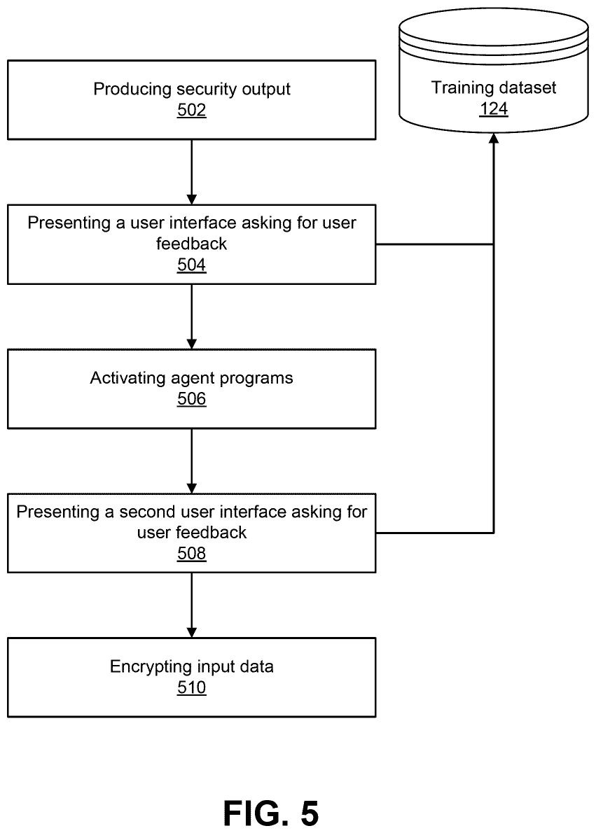

Turning now to FIG. 5, example operations are shown for incorporating user feedback, in various embodiments user feedback may be requested and/or collected at several stages during the autonomous and dynamic security configuration generation system 130 processes.

As shown by operation 502, the apparatus 200 may include means, such as processor 202, memory 204, communications hardware 206, extraction circuitry 208, classification circuitry 210, cryptographic circuitry 211, agent circuitry 212, or the like for producing a security category classification and security configuration, via the LM 122, in the processes described above in relation to FIG. 1 and FIG. 3.

As shown by operation 504, the apparatus 200 may include means, such as communications hardware 206, or the like for causing display of a user interface comprising confirmation information related to the cryptographic output and the security category. For example, user feedback may be requested, via the communications hardware 206, presenting a user interface to be displayed on a screen connected to the computing device running the automatic cryptographic operation determination system 130. In various embodiments, the user feedback may be requested to confirm the security category classification of input data 110a. If for example, the user agrees with the category classification of input data 110a, the LM 122 may continue and instantiate agent programs to carry out the determined cryptographic operations. In another example, if the user disagrees with the security category classification of input data 110a, the user may determine the security category classification which may be used subsequently by the LM 122 and the agent circuitry 212. The feedback may be added to the training dataset(s) 124, which may improve the accuracy of subsequent automatic cryptographic operation determination.

As shown by operation 506, the apparatus 200 may include means, such as processor 202, memory 204, cryptographic circuitry 211, agent circuitry 212, or the like for activating agent programs. As previously described above (FIG. 1 and FIG. 2), agent programs may be activated and/or controlled by cryptographic circuitry 211 to conduct cryptographic operations in relation to the security configuration produced by LM 122 and the cryptographic circuitry 211.

As shown by operation 508, the apparatus 200 may include means, such as communications hardware 206, or the like for presenting a second user interface asking for user feedback. In some embodiments the communications hardware 206 may present the user interface via a connected display. The user feedback may be requested on the final encryption determinations of the autonomous and dynamic security configuration generation system 130, such as the key length, encryption algorithm, and the like. In one example, the user may be asked to confirm the use of a specific encryption algorithm and a specific encryption key length, if the user confirms that both these cryptographic operations would provide the necessary security for input data 110a, the encryption process may begin, through the use of agent programs (e.g., cryptographic operations agent 112, key generation agent 108, etc.). If, for example, the user does not agree with the determined cryptographic operations produced by the LM 122 and the agent programs, the user may provide their own cryptographic operations (e.g., encryption algorithms, key length, etc.). Any feedback may be provided to the training dataset(s) 124, via communications network 104, which may improve subsequent processing by the cryptographic operation determination system 130.

As shown by operation 510, the apparatus 200 may include means, such as processor 202, memory 204, agent circuitry 212, or the like for encrypting input data 110a. As previously described above in detail (FIGS. 1-3), agent programs may conduct encryption operations, including but not limited to the encryption and/or signing of input data 110a, to produce encrypted data 110b.

FIGS. 3, 4, and 5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 3-5 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved cryptographic operation determination. Example embodiments thus provide tools that overcome the problems faced by user determined cryptographic operations, example embodiments thus save time and resources, while also eliminating the possibility of human error, while ensuring cryptographic operations in line with organizational best practices. Finally, by automating cryptographic operation determination, the speed and consistency of the evaluations performed by example embodiments unlocks many potential new functions, such as the automatic maintenance and storage of encrypted data, without the need for user interaction to ensure the security of the data.

As these examples all illustrate, example embodiments contemplated herein provide technical solutions that solve real-world problems faced during cryptographic operation determination. And while cryptographic operation determination has been an issue for decades, the recent availability if quantum computing by recently emerging technology today has made this problem significantly more acute as the demand for cryptographic operation determination has grown significantly while the required complexity of cryptographic operations has itself increased. At the same time, the recently rising ubiquity of artificial intelligence models has unlocked new avenues for solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for autonomous and dynamic security configuration generation, the method comprising:
receiving, by communications hardware, input data to be protected;
creating, by extraction circuitry and based on the input data, a set of analysis data comprising metadata about the input data;
generating, by classification circuitry and using the set of analysis data, a security category for the input data; and
deriving, by cryptographic circuitry running a language model, a security configuration based on the security category and a training dataset comprising institutional best practice for the security configuration.

2. The method of claim 1, wherein the set of analysis data further comprises sample text,
wherein the method further comprises processing the set of analysis data to construct an input prompt based on the sample text,
wherein generating the security category further comprises ingesting the set of analysis data and the input prompt by a language model to produce the security category.

3. The method of claim 1, further comprising:
causing, by agent circuitry and based on the security configuration, instantiation of an agent program; and
causing, by the cryptographic circuitry, the agent program to execute, based on the security configuration, a cryptographic operation on the input data to produce a cryptographic output.

4. The method of claim 3, wherein executing the cryptographic operation comprises:
encrypting, by the agent program, the input data based on the security configuration.

5. The method of claim 3, wherein executing the cryptographic operation comprises:
digitally signing, by the agent program, the input data based on the security configuration.

6. The method of claim 3, further comprising:
producing, by a quantum computer-based cryptographic analysis model, a quantum-based security analysis comprising an effective strength of the cryptographic output.

7. The method of claim 6, further comprising:
determining, by the cryptographic circuitry, whether the effective strength of the cryptographic output is less than a pre-determined threshold; and
in an instance in which the effective strength of the cryptographic output is determined to be less than a pre-determined threshold, generating, by the cryptographic circuitry using a language model, an updated security configuration based on the security category and the quantum-based security analysis.

8. The method of claim 6, wherein producing the quantum-based security analysis comprises determining a private key based on the cryptographic output,
wherein the quantum-based security analysis comprises the private key determined from the cryptographic output.

9. The method of claim 6, wherein the security configuration includes a cryptographic key, wherein the security configuration further comprises a key rotation schedule, wherein the method further comprises:
causing, by the agent circuitry, instantiation of a key rotation agent configured to change the cryptographic key based on the key rotation schedule.

10. The method of claim 3, further comprising:
causing, by the communications hardware, presentation of a user interface comprising confirmation information related to the cryptographic output and the security category.

11. An apparatus for autonomous and dynamic security configuration generation, the apparatus comprising:
communications hardware configured to:
receive input data to be protected;
extraction circuitry configured to:
create a set of analysis data based on the input data;
classification circuitry configured to:
analyze, using a language model, the set of analysis data to determine a security category of the input data, and
cryptographic circuitry configured to:
derive a security configuration based on the security category.

12. The apparatus of claim 11, further comprising agent circuitry configured to:
instantiate, based on the security configuration, an agent program configured to produce a cryptographic output, and
cause execution by the agent program of a cryptographic operation on the input data based on the security configuration to produce the cryptographic output.

13. The apparatus of claim 12, wherein the agent circuitry is further configured so that causing execution of the cryptographic operation comprises:
encrypting the input data based on the security configuration.

14. The apparatus of claim 12, wherein the agent circuitry is further configured so that causing execution of the cryptographic operation comprises:
digitally signing the input data based on the security configuration.

15. The apparatus of claim 11, wherein the set of analysis data comprises sample text and metadata,
wherein the classification circuitry is configured to (1) analyze the set of analysis data by constructing an input prompt comprising the sample text, and (2) determine the security configuration based on the metadata.

16. The apparatus of claim 12, further comprising a quantum computer configured to:
produce, by a quantum computer-based cryptographic analysis model, a quantum-based security analysis comprising an effective strength of the cryptographic output.

17. The apparatus of claim 16, wherein the quantum computer is further configured to:
determine a private key based on the cryptographic output,
wherein the quantum-based security analysis comprises the private key determined from the cryptographic output.

18. The apparatus of claim 16, wherein the cryptographic circuitry is further configured to:
in an instance in which the effective strength of the cryptographic output is determined to be less than a pre-determined threshold, generating, by the cryptographic circuitry using the language model, an updated security configuration based on the security category and the quantum-based security analysis.

19. The apparatus of claim 12 wherein the agent circuitry is further configured to:
in an instance in which the security configuration includes a cryptographic key, wherein the security configuration further comprises a key rotation schedule,
instantiate a key rotation agent configured to change the cryptographic key based on the key rotation schedule.

20. An apparatus for autonomous and dynamic security configuration generation, the apparatus comprising:
means for receiving input data to be protected;
means for creating, based on the input data, a set of analysis data comprising metadata about the input data;
means for generating, using the set of analysis data, a security category for the input data; and
means for deriving, using a language model, the security configuration based on the security category and a training dataset comprising institutional best practice for the security configuration.
